(19) United States
(12) Patent Application Publication
(10) Pub. No.: US 2026/0205735 A1
(43) Pub. Date: Jul. 16, 2026

(54) AUDIO PROCESSING METHOD AND SYSTEM FOR HARMONIC RESTORATION

(71) Applicant: MEDIATEK INC., Hsinchu City (TW)

(72) Inventors: Yun-Shao Lin, Hsinchu City (TW); Jen-Wei Huang, Hsinchu City (TW); Tsung-Han Lee, Hsinchu City (TW); Liang-Che Sun, Hsinchu City (TW); Yiou-Wen Cheng, Hsinchu City (TW)

(73) Assignee: MEDIATEK INC., Hsinchu City (TW)

(21) Appl. No.: 19/446,949

(22) Filed: Jan. 13, 2026

Related U.S. Application Data
(60) Provisional application No. 63/744,444, filed on Jan. 13, 2025.

(51) Int. Cl. H04R 3/04; G10H 1/36

(52) U.S. Cl. CPC H04R 3/04; G10H 1/366; G10H 2210/311; H04R 2499/11

(57) ABSTRACT

An audio processing method implemented by a processor includes receiving a first audio signal and a second audio signal, performing cancellation of audio components in the first audio signal using the second audio signal to reduce or remove harmonic components associated with the second audio signal, and applying a restoration process associated with a voice to the cancelled signal to generate a restored voice signal. The method addresses acoustic coupling issues by combining echo cancellation with generative artificial intelligence-based voice restoration, resulting in high-quality voice recording through built-in device components and preserving natural vocal characteristics.

### CROSS REFERENCE TO RELATED APPLICATIONS

This application claims the benefit of U.S. Provisional Application No. 63/744,444, filed on Jan. 13, 2025. The content of the application is incorporated herein by reference.

### BACKGROUND

Mobile audio recording applications have gained widespread popularity, allowing users to record vocals with music tracks using their smartphones or mobile devices. However, conventional mobile audio recording systems face technical challenges in achieving high-quality audio recording using only the device's built-in components.

Existing echo cancellation techniques can reduce music interference but often damage the harmonic structure of the voice signal in the process. This results in recordings that sound processed or unnatural, lacking the rich harmonic content that characterizes high-quality vocal performances. There is a need for an audio processing system that can achieve studio-quality voice recording using only built-in mobile device components, while maintaining the natural harmonic characteristics of the singing voice and enabling hands-free operation without external equipment.

### SUMMARY

An embodiment provides an audio processing method implemented by a processor. The method includes receiving a first audio signal and a second audio signal, performing cancellation of audio components in the first audio signal using the second audio signal to reduce or remove harmonic components associated with the second audio signal, and applying a restoration process associated with a voice to the cancelled signal to generate a restored voice signal.

An embodiment provides an audio processing device including a memory storing instructions and a processor coupled to the memory. When executing the instructions, the processor is configured to receive a first audio signal and a second audio signal, cancel audio components in the first audio signal using the second audio signal to reduce or remove harmonic components associated with the second audio signal, and apply a restoration process associated with a voice to the cancelled signal and generate a restored voice signal.

To the accomplishment of the foregoing and related ends, certain embodiments comprise the features hereinafter fully described and particularly pointed out in the claims. The following description and accompanying drawings set forth in detail certain illustrative aspects of the embodiments. These aspects are indicative, however, of but a few of the various ways in which the principles of the embodiments may be employed, and the present disclosure is intended to include all such aspects and their equivalents. These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 depicts a block diagram of an audio processing system for processing audio signals according to an embodiment.

FIGS. 2A to 2B depict spectrograms illustrating the characteristics of input audio signals according to an embodiment.

FIGS. 2C to 2D depict spectrograms illustrating audio processing results at different stages of the system according to an embodiment.

FIG. 2E depicts a spectrogram of an output audio signal processed by a remix block according to an embodiment of the present invention.

FIG. 3 depicts a schematic diagram of an audio processing device implementing the audio processing system according to an embodiment.

FIG. 4 depicts a schematic diagram of an audio processing device configured to remove environmental noise using generative voice restoration AI according to an embodiment.

FIG. 5 depicts a flow diagram of an audio processing method according to an embodiment.

### DETAILED DESCRIPTION

The present disclosure provides a detailed description of various embodiments. While specific implementation details are presented herein to facilitate a comprehensive understanding of the disclosure, it will be apparent to those skilled in the art that the present invention may be realized without necessarily adhering to all such particularities. In certain instances, well-established methods, procedures, components, and circuits have been omitted from exhaustive description to avoid obscuring the present disclosure. It should be understood that technical features individually described in relation to a single drawing may be implemented either discretely or in combination with other features, as set forth in the present specification.

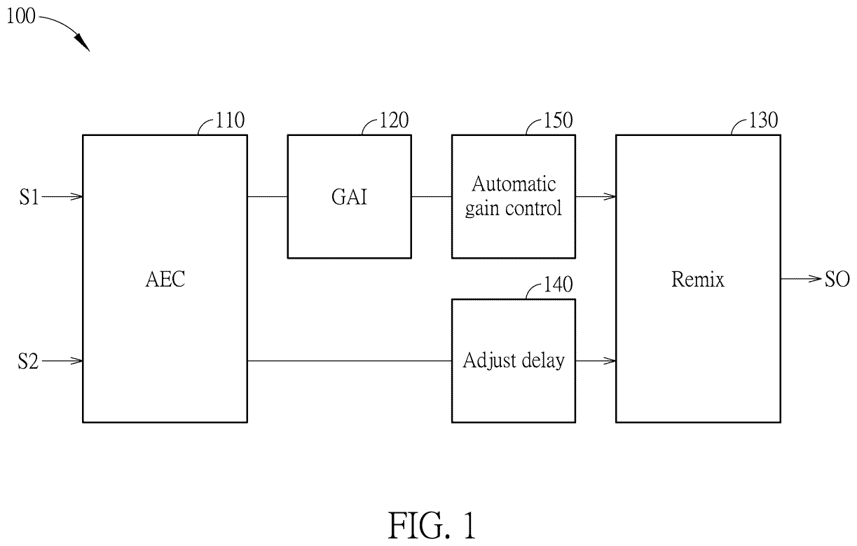

FIG. 1 illustrates a block diagram of an audio processing system 100 for processing audio signals according to an embodiment. The system 100 receives two input signals and processes them through a series of processing blocks to generate an output audio signal SO.

The system 100 receives a first input signal, referred to as an uplink audio signal S1, and a second input signal, referred to as a downlink audio signal S2. Both the uplink audio signal S1 and the downlink audio signal S2 are provided as inputs to an acoustic echo cancellation (AEC) block 110.

The AEC block 110 performs acoustic echo cancellation processing on the uplink audio signal S1 using the downlink audio signal S2 as a reference. The AEC block 110 operates to reduce or remove audio components in the uplink audio signal S1 that correspond to or are derived from the downlink audio signal S2. The output of the AEC block 110 is a processed signal with reduced echo components.

The processed signal from the AEC block 110 is provided as an input to a generative voice restoration AI block 120. The generative voice restoration AI block 120 applies generative AI based voice-restoration method, for example, perform noise reduction to remove the non-speech noise or restore harmonic components associated with voice signals that may have been degraded or removed during the acoustic echo cancellation process. The AI block 120 generates a restored voice signal with enhanced harmonic content.

The output of the generative voice restoration AI (GAI) block 120 is provided to an automatic gain control block 150. The Automatic Gain Control block 150 adjusts the amplitude or gain of the restored voice signal to maintain appropriate signal levels.

The downlink audio signal S2 is also provided to an adjust delay block 140, which applies timing adjustments to align the downlink audio signal S2 with the processed voice signal from the restoration process.

The outputs of the automatic gain control block 150 and the adjust delay block 140 are both provided as inputs to a remix block 130. The remix block 130 combines the gain-controlled restored voice signal with the delay-adjusted downlink audio signal S2 to generate a final mixed audio signal. The remix block 130 outputs the combined signal as the output audio signal SO.

The system 100 thus provides a complete audio processing pipeline that receives separate uplink and downlink audio signals, removes unwanted audio components, restores voice quality using artificial intelligence, and produces a high-quality mixed output audio signal SO suitable for recording or further processing.

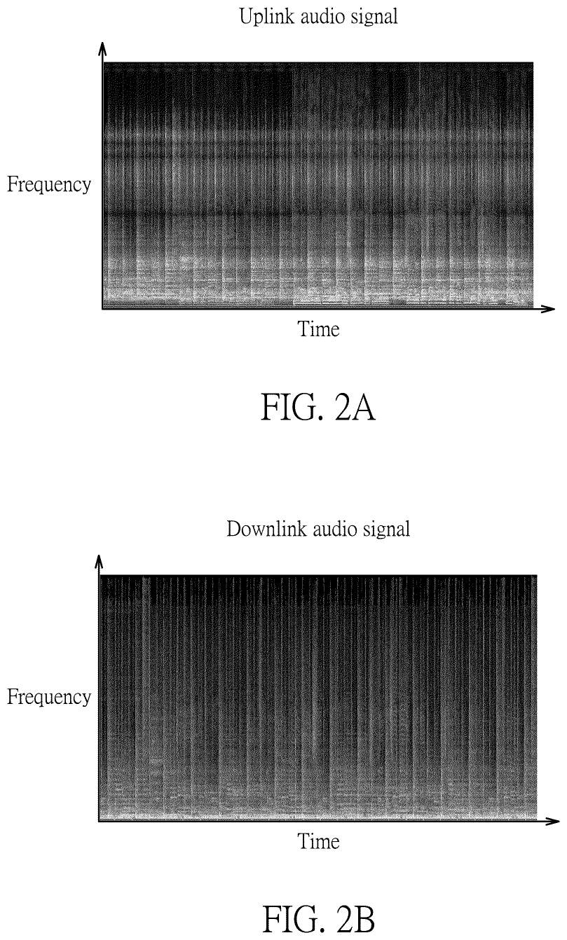

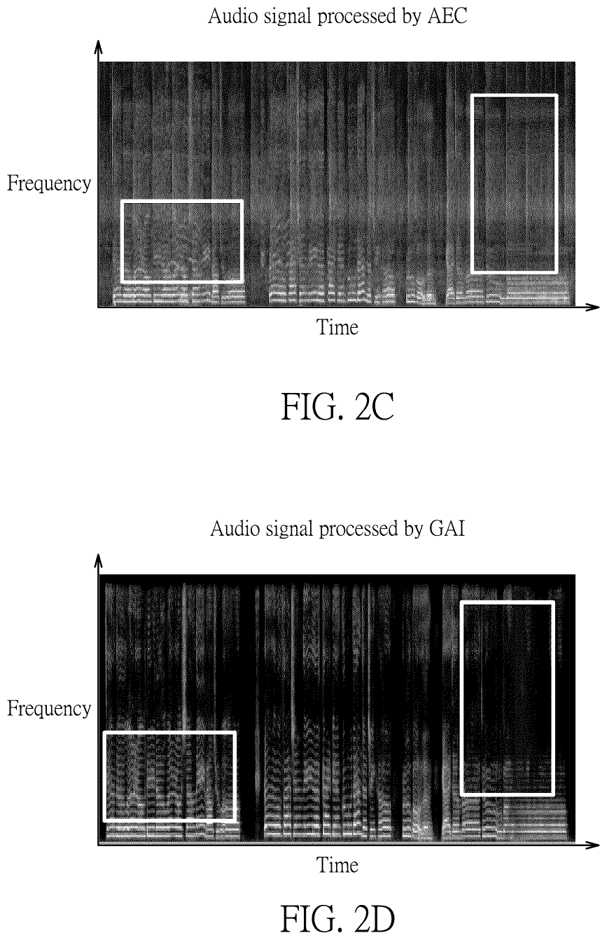

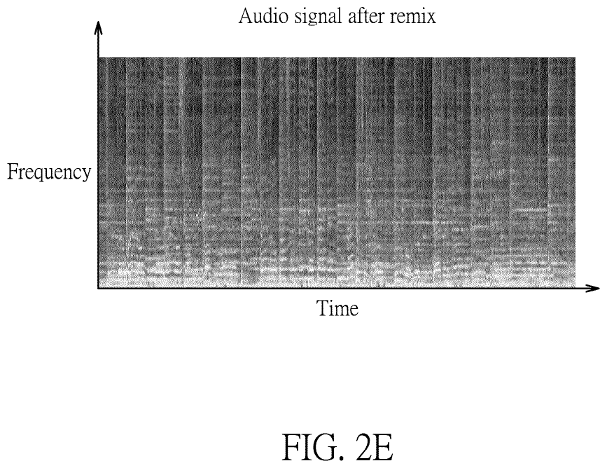

FIGS. 2A and 2B depict spectrograms illustrating the characteristics of input audio signals according to an embodiment. The spectrograms show frequency content over time, with frequency represented on the vertical axis and time represented on the horizontal axis. The intensity or magnitude of frequency components is represented by color coding, with brighter colors indicating higher energy levels.

FIG. 2A depicts a spectrogram of an uplink audio signal, which represents recorded audio captured by a microphone. The uplink audio signal includes a combination of voice content and leaked music played from speaker. As shown in the spectrogram, the uplink audio signal contains clear voice components with distinct harmonic patterns visible in the frequency domain. However, the signal also includes weaker music components that may have leaked from the device speaker into the microphone recording. The music components in the uplink audio signal can exhibit reduced quality and lower intensity compared to the original music source, as indicated by the less distinct frequency patterns in certain regions of the spectrogram.

FIG. 2B depicts a spectrogram of a downlink audio signal, which represents the original high-quality music soundtrack. The downlink audio signal exhibits clear, well-defined frequency content with rich harmonic structure across the frequency spectrum. The spectrogram shows strong, consistent frequency components with full bass response evident in the lower frequency regions. The downlink audio signal may maintain high fidelity with distinct frequency patterns and strong energy distribution across the frequency range, representing the pristine audio quality of the original music track before any processing or acoustic coupling effects.

The comparison between FIGS. 2A and 2B illustrates the difference in audio quality between the mixed uplink audio signal containing both voice and degraded music components, and the clean downlink audio signal containing only the high-quality original music. This difference demonstrates the need for the audio processing system to separate and enhance the voice components while utilizing the high-quality downlink audio signal for final remixing operations.

FIGS. 2C and 2D depict spectrograms illustrating the audio processing results at different stages of the system according to an embodiment of the present invention. Both spectrograms show frequency content over time, with frequency represented on the vertical axis and time represented on the horizontal axis. The boxes in the spectrograms highlight specific regions to emphasize the differences in harmonic structure before and after voice restoration processing.

FIG. 2C depicts a spectrogram of an audio signal processed by AEC (for example, AEC block 110). The audio signal processed by AEC shows the result after acoustic echo cancellation processing has been applied to remove music components from the uplink audio signal. As illustrated in the spectrogram, the majority of the music content has been eliminated from the signal. However, some residual music components may still remain, as evidenced by faint frequency patterns that can be observed in certain regions of the spectrogram. Additionally, the acoustic echo cancellation process may have affected the harmonic structure of the voice components, resulting in voice frequency bands with less distinct or unclear harmonic content compared to the original voice signal. The highlighted regions in the boxes show that the harmonic patterns (horizontal striped patterns in the voice frequency bands) are only partially visible across the frequency spectrum, with some frequency bands showing unclear or missing harmonic content compared to what should be present for natural voice signals.

FIG. 2D depicts a spectrogram of an audio signal processed by GAI (for example, GAI block 120), which represents the result after generative voice restoration processing. The audio signal processed by GAI may demonstrate improved voice quality with complete and restored voice characteristics. The audio signal processed by GAI block 120 demonstrates improved voice quality with complete and restored voice characteristics. The highlighted regions in the boxes show that the harmonic patterns (horizontal striped patterns) have become more visible and well-defined across all frequency bands. This demonstrates the regeneration of voice harmonics that were previously missing or degraded, resulting in a more complete spectral representation of the natural singing voice. The restored harmonics contribute to improved perceptual quality and naturalness, making the voice sound fuller and richer while eliminating residual noise artifacts. The spectrogram shows enhanced harmonic structure with well-defined frequency patterns that represent the natural harmonic content of the singing voice. The generative AI processing can reconstruct and restore harmonic components that may have been degraded or removed during the acoustic echo cancellation stage, resulting in a voice signal with improved perceptual quality and naturalness.

The comparison between FIGS. 2C and 2D illustrates the effectiveness of the generative voice restoration AI in recovering and enhancing voice quality after acoustic echo cancellation processing. The transformation from the audio signal processed by AEC block 110 to the audio signal processed by GAI block 120 demonstrates how the AI-based restoration process can regenerate missing or damaged harmonic frequencies or remove the non-speech noise in some embodiments to produce a high-quality voice signal suitable for final audio mixing.

FIG. 2E depicts a spectrogram of an output audio signal processed by the remix block 130 according to an embodiment of the present invention. The spectrogram shows frequency content over time, with frequency represented on the vertical axis and time represented on the horizontal axis.

The output audio signal processed by remix block 130 represents the output audio signal SO that combines the restored voice signal from GAI block 120 with the delay-adjusted downlink audio signal. As illustrated in the spectrogram, the final mixed output audio signal exhibits both high-quality voice characteristics and rich musical content across the frequency spectrum. The spectrogram shows well-defined harmonic patterns in the voice frequency ranges, indicating that the restored voice components maintain their enhanced quality after the remixing process.

The lower frequency regions of the spectrogram demonstrate strong, consistent musical content with full bass response, indicating that the high-quality downlink audio signal has been effectively integrated into the final mix. The overall frequency distribution shows balanced energy levels across the spectrum, with clear separation between voice and music components while maintaining natural blending between the two audio sources.

In some embodiments, the output audio signal can achieve studio-quality recording characteristics by combining the AI-restored voice signal with the original music track. The resulting mixed output audio signal may be suitable for various applications including storage, playback, or transmission to social media platforms, providing users with a professional-quality karaoke recording using only the device's built-in audio components.

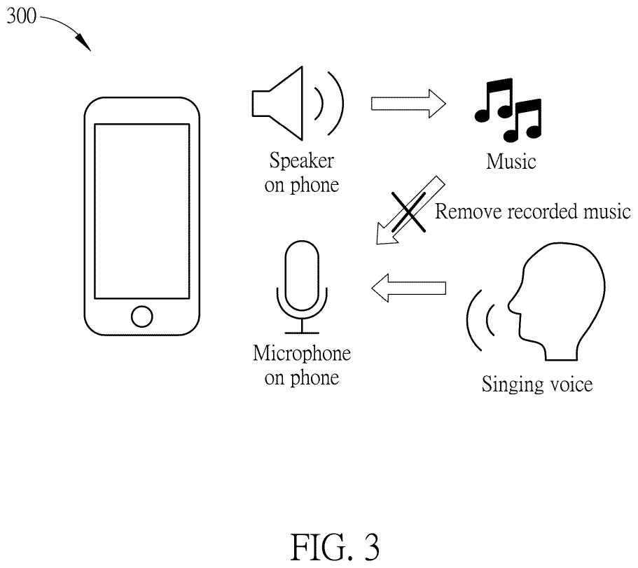

FIG. 3 depicts a schematic diagram of an audio processing device 300 implementing the audio processing system according to an embodiment of the present invention. FIG. 3 illustrates the basic operational configuration and signal flow within a handheld mobile device.

The audio processing device 300 may be a mobile phone or smartphone having a housing that encloses the various components. The device 300 includes a speaker positioned on the phone and a microphone positioned on the phone, both integrated within the device housing. The speaker and microphone may be disposed in close proximity to each other, enabling hands-free audio interaction by a user.

The operational flow shows the speaker on the phone outputting music audio signals. Simultaneously, a user provides singing voice input, which is captured by the microphone on the phone along with any leaked music from the speaker. The audio processing system performs audio processing to remove recorded music from the microphone signal. This processing separates the singing voice from the unwanted music components that may have been picked up by the microphone during recording.

The configuration shown in FIG. 3 demonstrates how the audio processing system can operate using only the built-in audio components of the mobile device 300, without requiring external microphones or headsets. The device housing may be dimensioned for handheld operation, and the speaker and microphone positioning enables the system to function in a hands-free mode while maintaining the ability to effectively separate voice and music signals through the described audio processing techniques.

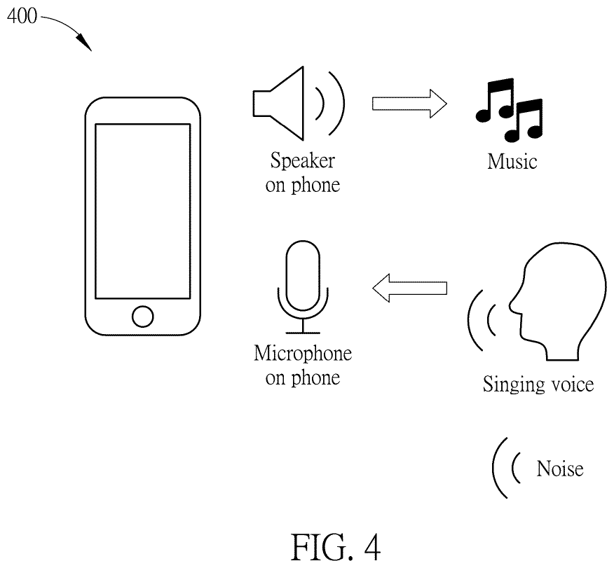

FIG. 4 depicts a schematic diagram of an audio processing device 400 configured to remove environmental disturbing noise by using generative voice restoration AI according to an embodiment of the present invention. The figure illustrates the operational configuration for noise reduction processing in various acoustic environments.

The audio processing device 400 may be a mobile phone or smartphone having a housing that encloses the processing components. The device 400 includes a speaker positioned on the phone and a microphone positioned on the phone, both integrated within the device housing. The speaker and microphone may be disposed in close proximity to each other, enabling hands-free audio interaction by a user in challenging acoustic environments.

The operational configuration depicted in FIG. 4 shows the speaker on the phone outputting music audio signals. A user provides singing voice input, which is captured by the microphone on the phone. However, in this embodiment, the microphone may also capture various types of environmental noise that can interfere with the voice recording quality.

The audio processing system can remove environmental disturbing noise by using generative voice restoration AI. The noise types that can be processed include multiple categories of acoustic interference: residual noise from AEC output, which includes any remaining noise artifacts that may persist after the acoustic echo cancellation processing stage; indoor noise such as baby cry, vacuum cleaner operation, dog barking, and other domestic noise sources that may be present during recording; and outdoor noise including traffic sounds, car engines, wind effects, and other ambient outdoor acoustic interference that can degrade voice recording quality.

The generative voice restoration AI processing facilitates the device 400 to effectively separate and enhance the singing voice signal while suppressing these various noise types. This capability allows users to achieve high-quality voice recordings even in acoustically challenging environments, whether indoors or outdoors, without requiring specialized recording equipment or controlled acoustic conditions.

The configuration shown in FIG. 4 demonstrates the robustness of the audio processing system in real-world usage scenarios where environmental noise may be unavoidable, providing users with studio-quality recording capabilities regardless of their acoustic surroundings.

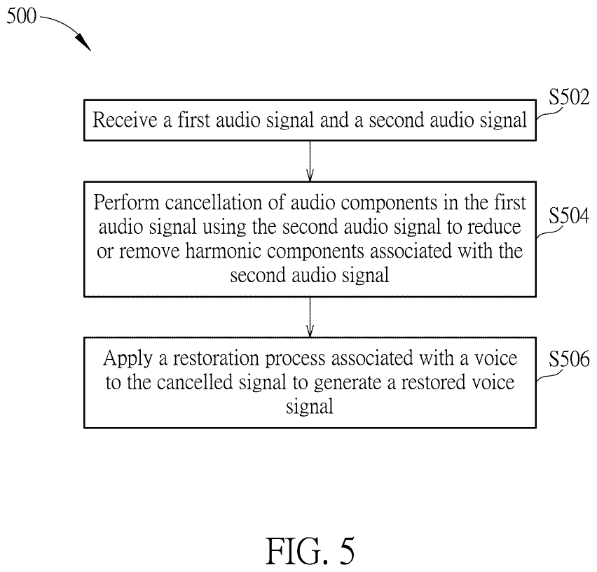

FIG. 5 depicts a flow diagram of an audio processing method 500 according to an embodiment. The method 500 includes the following steps:

S502: Receive a first audio signal and a second audio signal;

S504: Perform cancellation of audio components in the first audio signal using the second audio signal to reduce or remove harmonic components associated with the second audio signal; and

S506: Apply a restoration process associated with a voice to the cancelled signal (for example, in order to remove residual noise or restore harmonic components) to generate a restored voice signal.

In step S502, the audio processing system receives two distinct input audio signals for processing. The first audio signal may include an uplink audio signal that is captured by a microphone and contains a combination of voice content and residual audio components. In some embodiments, the uplink audio signal includes the user's singing voice along with leaked music that has been picked up from the device speaker. The second audio signal may include a downlink audio signal that contains, for example, the original high-quality music soundtrack or background audio. The downlink audio signal serves as a reference signal and maintains pristine audio quality without degradation from acoustic coupling effects. Both audio signals are received simultaneously and provided as inputs to the audio processing pipeline for subsequent processing stages.

In step S504, the system performs acoustic echo cancellation processing to eliminate unwanted audio components from the first audio signal. The cancellation process uses the second audio signal as a reference to identify and remove harmonic components that originate from the second audio signal but have leaked into the first audio signal. This step may involve applying an adaptive filter to estimate the audio path between the second audio signal and the first audio signal, accounting for acoustic coupling between the speaker and microphone. The acoustic echo cancellation adaptively estimates the transfer function of the acoustic path and subtracts the estimated echo signal from the first audio signal. This processing enhances the signal-to-noise ratio (SNR) of the voice components by reducing or eliminating the music interference. However, the cancellation process may also inadvertently affect some harmonic components of the voice signal, potentially degrading the natural harmonic structure of the singing voice.

In step S506, the system applies an advanced restoration process to the cancelled signal output from step S504 to recover and enhance voice quality. In some embodiments, the restoration process may involve applying a generative artificial intelligence (AI) model that has been specifically trained to remove noise or reconstruct harmonic components of singing voices. The generative AI model analyzes the cancelled signal and generates missing or damaged harmonic frequencies to improve the perceptual quality of the voice signal. This restoration process can reconstruct the natural harmonic structure of the singing voice that may have been degraded during the acoustic echo cancellation stage. The AI model intelligently fills in frequency gaps and enhances the overall spectral richness of the voice signal, resulting in a restored voice signal with studio-quality characteristics. The output of this step is a high-quality voice signal with enhanced harmonic content that maintains the natural characteristics of the original singing voice while being substantially free from unwanted music interference.

The terminology used in this description is intended to explain particular embodiments and should not be viewed as limiting. The singular forms “a,” “an,” and “the” include plural forms unless the context clearly indicates otherwise. The term “and/or” covers any combination of listed items. Terms such as “includes,” “including,” “comprises,” and “comprising” indicate the presence of stated features but do not exclude additional features or components.

Expressions like “coupled,” “connected,” “electrically connected,” and similar terms broadly denote electrical or electronic connection. An entity is in “communication” with another when it transmits or receives signals, whether image, voice, data, or control, and whether analog or digital, through wired or wireless means. These terms encompass all relevant electrical connectivity.

Ordinal labels such as “first,” “second,” etc. are used only to distinguish between instances of similar elements. They do not imply sequence, priority, or order unless expressly stated. Likewise, directional terms such as up, down, left, right, or front and back refer only to the orientation in the figures and are not intended to limit the scope. Elements described may exist in alternative forms recognized by those skilled in the art.

Approximation terms such as “substantially,” “approximately,” “generally,” and “about” account for variations in precision, tolerances, measurement, and material properties. Depending on the context, variation may range from ±20% to progressively tighter tolerances (±10%, ±5%, ±1%, or less). The degree of approximation depends on the described component, the embodiment, and the technical understanding of skilled practitioners.

The components, logic, circuits, and processes described may be implemented in hardware, firmware, software, or combinations thereof. The form of implementation depends on the application and design constraints. Hardware for such implementations may include, without limitation, processors, DSPs, ASICs, FPGAs, PLDs, gate logic, discrete components, or combinations. These are configured to perform the described functions.

A general-purpose processor may be a microprocessor, controller, microcontroller, or state machine, or a combination such as DSP plus microprocessor. In some cases, processes are executed by function-specific circuitry optimized for performance, efficiency, or cost. Hardware selection depends on application requirements, including speed, power, cost, and size constraints.

The aspects described in this specification can be implemented through both hardware and software instructions. These instructions may be stored on various types of computer-readable media, including but not limited to Random Access Memory (RAM), flash memory, Read Only Memory (ROM), Electrically Programmable ROM (EPROM), Electrically Erasable Programmable ROM (EEPROM), registers, hard disks, removable disks, CD-ROMs, or any other form of storage medium known in the art. In a typical configuration, the storage medium is connected to a processor, enabling the processor to read information from and write information to the medium. In some configurations, the storage medium may be integral to the processor itself.

Various modifications will be apparent to those skilled in the art, and the principles herein may apply to alternative embodiments without departing from the scope of this disclosure. The claims are intended to cover the widest scope consistent with the disclosed principles and features.

Embodiments may include explicitly disclosed features as well as optional features not described in detail. Conversely, some implementations may omit features not explicitly disclosed. Such omissions do not narrow the breadth of the claimed subject matter, provided that the disclosed features are present.

Features described separately may also be combined into a single implementation. Conversely, features described in a single embodiment may be divided into separate implementations or subcombinations. Even where combinations are initially claimed, one or more features may be removed or rearranged without departing from the invention.

Depictions of process sequences in the drawings should not be taken as strict requirements. Operations may occur in different orders or concurrently, and additional unillustrated operations may be inserted. Similarly, schematic diagrams and figures are illustrative, not to scale, and not intended as precise technical drawings. They facilitate understanding but do not limit the invention to the depicted arrangements.

Multitasking and parallel processing may be advantageous in certain cases. Described components may be shown as separate but could be integrated, depending on implementation needs. Software components may be packaged together or distributed across systems as appropriate. Other embodiments beyond those described are within the scope of the claims. The order of actions in the claims may vary while still achieving the desired outcomes. This flexibility in execution is part of the invention.

While the invention has been described in connection with certain embodiments, it will be understood by those skilled in the art that various modifications and adaptations can be made without departing from the scope of the invention. The specific embodiments presented are intended to illustrate the invention and not to limit its application or construction. Those skilled in the art will readily observe that numerous modifications and alterations of the device and method may be made while retaining the teachings of the invention. Accordingly, the above disclosure should be construed as limited only by the metes and bounds of the appended claims

What is claimed is:

1. An audio processing method implemented by a processor, the method comprising:
receiving a first audio signal and a second audio signal;
performing cancellation of audio components in the first audio signal using the second audio signal to reduce or remove harmonic components associated with the second audio signal; and
applying a restoration process associated with a voice to the cancelled signal to generate a restored voice signal.

2. The method of claim 1, wherein the first audio signal comprises a voice with leaked music, and the second audio signal comprises music.

3. The method of claim 1, further comprising:
remixing the restored voice signal with the second audio signal to generate an output audio signal; and
outputting the output audio signal.

4. The method of claim 3, wherein remixing the restored voice signal comprises aligning the restored voice signal with the second audio signal by adjusting delay and applying automatic gain control.

5. The method of claim 3, wherein outputting the output audio signal comprises storing the output audio signal or transmitting the output audio signal.

6. The method of claim 1, wherein the cancellation comprises performing acoustic echo cancellation using an adaptive filter to estimate an audio path between the second audio signal and the first audio signal.

7. The method of claim 1, wherein the restoration process comprises applying a generative artificial intelligence (AI) model trained to remove non-speech noise or reconstruct harmonic components of a voice.

8. The method of claim 7, wherein the restoration process comprises generating missing harmonic frequencies of the voice.

9. An audio processing device comprising:
a memory storing instructions; and
a processor coupled to the memory and, when executing the instructions, configured to:
receive a first audio signal and a second audio signal;
cancel audio components in the first audio signal using the second audio signal to reduce or remove harmonic components associated with the second audio signal; and
apply a restoration process associated with a voice to the cancelled signal to generate a restored voice signal.

10. The device of claim 9, further comprising a speaker and a microphone disposed in close proximity to each other.

11. The device of claim 9, wherein the device comprises a housing enclosing the processor, the memory, the speaker, and the microphone, the housing being dimensioned for handheld operation.
